(19) United States
(12) Patent Application Publication
(10) Pub. No.: US 2026/0201901 A1
(43) Pub. Date: Jul. 16, 2026

(54) FAN, AIR CONDITIONING OUTDOOR UNIT, AND AIR CONDITIONING APPARATUS

(71) Applicant: DAIKIN INDUSTRIES, LTD., Osaka (JP)

(72) Inventors: Toru IWATA, Osaka (JP); Masahito HIGASHIDA, Osaka (JP); Tomohiro ISHIBASHI, Osaka (JP); Shota YAMADA, Osaka (JP)

(21) Appl. No.: 19/532,795

(22) Filed: Feb. 6, 2026

Related U.S. Application Data
(63) Continuation of application No. PCT/JP2024/021706, filed on Jun. 14, 2024.

(30) Foreign Application Priority Data
Aug. 8, 2023 (JP) 2023-128974

(51) Int. Cl. F04D 29/42; F04D 29/28; F04D 29/66; F24F 1/38; F24F 13/24

(52) U.S. Cl. CPC F04D 29/4226; F04D 29/281; F04D 29/664; F24F 1/38; F24F 2013/242

(57) ABSTRACT

A fan includes an impeller, and a casing. The casing includes a first wall portion having a spiral shape extending along an outer peripheral edge of the impeller, a suction port at one end in a direction of a rotational axis of the impeller, an air passage extending along an inner surface of the first wall portion to be in communication with the suction port and in which an airflow moving from one end toward an other end of the first wall portion is formed, and a blow-out port. The other end of the first wall portion is at a position obtained by rotating at least 360°, with a position of a tongue portion formed at the one end of the first wall portion as a starting point, about the rotational axis in a rotational direction of the impeller.

### CROSS-REFERENCE TO RELATED APPLICATIONS

This application is a continuation of, and claims the benefit of priority from International Application No. PCT/JP2024/021706, filed on June 14, 2024, which claims the benefit of priority from Japanese Patent Application No. 2023-128974, filed on August 8, 2023, the entire contents of each are incorporated herein by reference.

### BACKGROUND

### Technical Field

The present disclosure relates to a fan, an air conditioning outdoor unit, and an air conditioning apparatus.

### Background Information

Japanese Unexamined Patent Application Publication No. 2010-156342 discloses a centrifugal fan including an impeller and a fan housing that houses the impeller. The fan housing includes a scroll-shaped peripheral wall covering the periphery of the impeller. The fan housing is provided with a silencing space surrounding an air inlet section into which air conveyed by the impeller flows.

### SUMMARY

A first aspect provides

a fan including an impeller (53) and a casing (50) configured to house the impeller (53),

in which the casing (50) includes

a first wall portion (56a) having a spiral shape extending along an outer peripheral edge of the impeller (53), and the casing (50) has

a suction port (71) at one end in a direction of a rotational axis (O) of the impeller (53),

an air passage (A) extending along an inner surface of the first wall portion (56a) to be in communication with the suction port (71) and in which an airflow moving from one end toward another end of the first wall portion (56a) is formed, and

a blow-out port (72) through which air in the air passage (A) is blown out to outside the casing (50), and

in which another end of the first wall portion (56a) is at a position obtained by rotating by 360° or more, with a position of a tongue portion (57) formed at one end of the first wall portion (56a) as a starting point, about the rotational axis (O) in a rotational direction of the impeller (53).

### BRIEF DESCRIPTION OF DRAWINGS

FIG. 1 is a schematic overall configuration diagram of an air conditioning apparatus according to an embodiment.

FIG. 2 is a configuration diagram illustrating refrigerant pipes and an airflow in the air conditioning apparatus.

FIG. 3 is a longitudinal sectional view of an air conditioning indoor unit.

FIG. 4 is a block diagram including main elements of the air conditioning apparatus.

FIG. 5 is a diagram illustrating a state of a second damper and an airflow inside a damper casing during an air-supplying operation.

FIG. 6 is a diagram illustrating a state of the second damper and an airflow inside the damper casing during an air-exhaust operation.

FIG. 7 is a cross-sectional view of a first fan orthogonal to a direction of a rotational axis.

FIG. 8 is an enlarged view of a portion enclosed by the dashed line in FIG. 7.

FIG. 9 is a top view of the first fan.

FIG. 10 is a cross-sectional view illustrating another embodiment and corresponding to FIG. 7.

FIG. 11 is a cross-sectional view illustrating another embodiment and corresponding to FIG. 7.

### DETAILED DESCRIPTION OF EMBODIMENT(S)

Embodiments of the present disclosure will be described below in detail with reference to the drawings. It is to be noted that the present disclosure is not limited to the embodiments described below, and various modifications can be made without departing from the technical spirit of the present disclosure. The drawings conceptually illustrate the present disclosure, and the dimensions, ratios, or numbers may be exaggerated or simplified as appropriate for ease of understanding. The terms "upper", "lower", "right", "left", "front", and "rear" used in the following description indicate the directions shown in the respective drawings. Exemplary embodiments will be described below in detail with reference to the drawings.

### (1) Outline of Configuration of Air Conditioning Apparatus

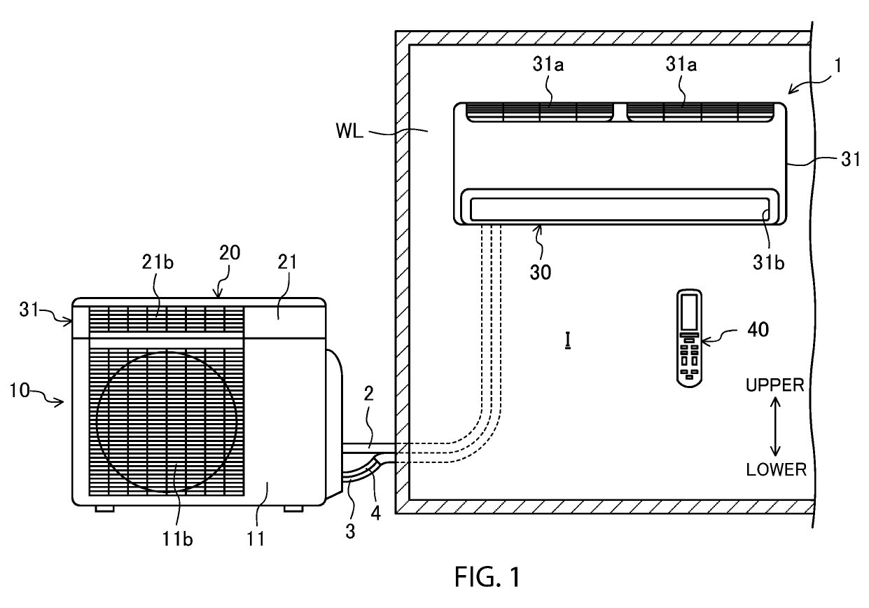

An air conditioning apparatus (1) controls the temperature and humidity of air in an interior (I). The interior (I) is an example of a target space (I). As illustrated in FIG. 1, the air conditioning apparatus (1) includes an air conditioning outdoor unit (10) and an air conditioning indoor unit (30). The air conditioning outdoor unit (10) is installed outdoors, and the air conditioning indoor unit (30) is installed indoors. The air conditioning apparatus (1) is of a pair type including the single air conditioning indoor unit (30) and the single air conditioning outdoor unit (10). The air conditioning apparatus (1) includes a humidity control unit (20) serving as a humidity control element. The air conditioning apparatus (1) has a function of humidifying and dehumidifying air. The air conditioning apparatus (1) also has a function of ventilating the interior (I).

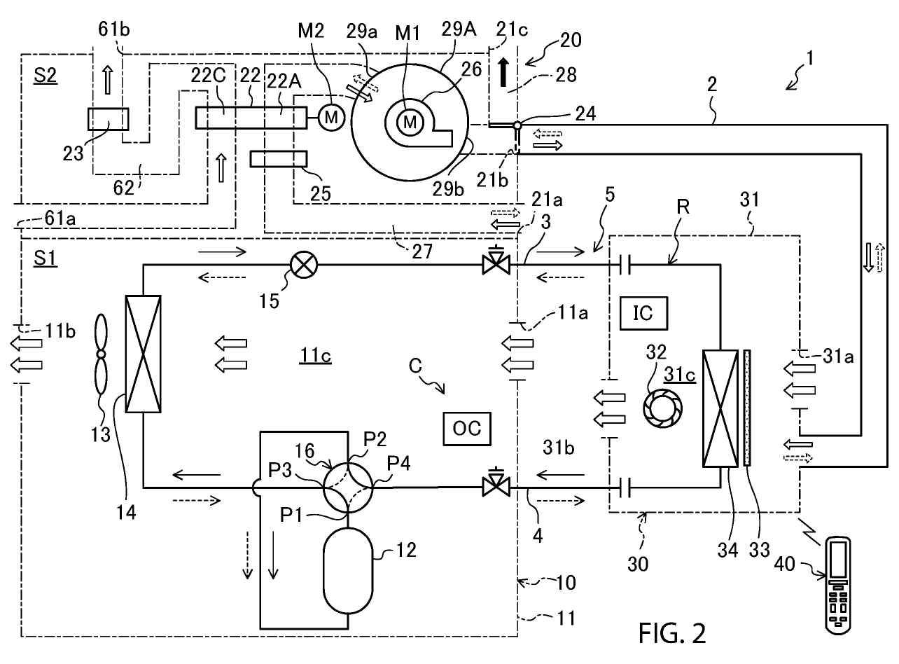

As illustrated in FIGS. 1 and 2, the air conditioning apparatus (1) includes a hose (2), a liquid connection pipe (3), and a gas connection pipe (4). The air conditioning indoor unit (30) and the humidity control unit (20) are connected to each other via the hose (2). The air conditioning indoor unit (30) and the air conditioning outdoor unit (10) are connected to each other via the liquid connection pipe (3) and the gas connection pipe (4). Thus, an air-conditioning element (5) including a refrigerant circuit (R) is configured. The liquid connection pipe (3) and the gas connection pipe (4) are examples of the connection pipe (3, 4) in the present disclosure. The refrigerant circuit (R) is filled with a refrigerant. The refrigerant circuit (R) performs a vapor-compression refrigeration cycle.

The refrigerant circuit (R) mainly includes a compressor (12), an outdoor heat exchanger (14), an expansion valve (15), a four-way switching valve (16), and an indoor heat exchanger (34).

The refrigerant circuit (R) performs a first refrigeration cycle and a second refrigeration cycle in accordance with switching of the four-way switching valve (16). The first refrigeration cycle is a refrigeration cycle in which the indoor heat exchanger (34) functions as an evaporator and the outdoor heat exchanger (14) functions as a radiator. The second refrigeration cycle is a refrigeration cycle in which the indoor heat exchanger (34) functions as a radiator and the outdoor heat exchanger (14) functions as an evaporator.

### (2) Detailed Configuration

### (2-1) Air Conditioning Outdoor Unit

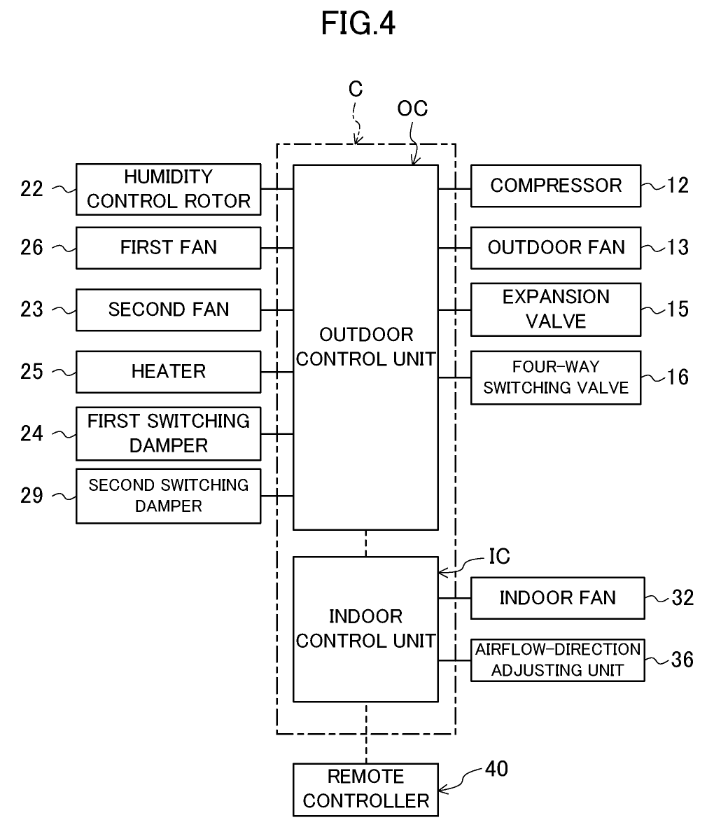

As illustrated in FIGS. 2 and 4, the air conditioning outdoor unit (10) includes an outdoor casing (11), the compressor (12), an outdoor fan (13), the outdoor heat exchanger (14), the expansion valve (15), and the four-way switching valve (16).

A partition plate (18) is provided inside the outdoor casing (11). The partition plate (18) partitions the inside of the outdoor casing (11) into a lower space (S1) and an upper space (S2). The compressor (12) and the outdoor heat exchanger (14) are provided in the lower space (S1). To be exact, the compressor (12), the outdoor fan (13), the outdoor heat exchanger (14), the expansion valve (15), and the four-way switching valve (16) are provided in the lower space (S1).

The outdoor casing (11) has an outdoor suction port (11a), an outdoor blow-out port (11b), a moisture-absorption-side suction port (61a), and a moisture-absorption-side exhaust port (61b). The outdoor suction port (11a) is formed in a rear portion of the outdoor casing (11). The outdoor suction port (11a) is an opening for suction of outdoor air (air outside). The outdoor blow-out port (11b) is formed in a front portion of the outdoor casing (11). The outdoor blow-out port (11b) is an opening for blowing-out of air that has passed through the outdoor heat exchanger (14). An outdoor air passage (11c) extending from the outdoor suction port (11a) to the outdoor blow-out port (11b) is formed inside the outdoor casing (11).

The compressor (12) draws in and compresses low-pressure gas refrigerant. The compressor (12) is a variable-capacity compressor in which electric power is supplied from an inverter circuit to a first motor (M1).

The outdoor fan (13) is disposed in the outdoor air passage (11c). Air conveyed by the outdoor fan (13) flows into the outdoor air passage (11c) through the outdoor suction port (11a) and is blown out to the outside through the outdoor blow-out port (11b). The air flowing in the outdoor air passage (11c) passes through the outdoor heat exchanger (14).

The outdoor heat exchanger (14) is disposed on the upstream side of the outdoor fan (13) in the outdoor air passage (11c). In this example, the outdoor heat exchanger (14) is a fin-and-tube type heat exchanger. The outdoor heat exchanger (14) exchanges heat between the refrigerant flowing therein and the air flowing in the outdoor air passage (11c).

The expansion valve (15) decompresses the refrigerant. The expansion valve (15) is an electrically controlled expansion valve having an adjustable opening degree. A decompressing mechanism may be a thermostatic expansion valve, an expansion machine, a capillary tube, or the like.

The four-way switching valve (16) has a first port (P1), a second port (P2), a third port (P3), and a fourth port (P4). The four-way switching valve (16) switches between the first refrigeration cycle and the second refrigeration cycle. Specifically, the four-way switching valve (16) is switchable between a first state (the state indicated by the solid lines in FIG. 2) and a second state (the state indicated by the dashed lines in FIG. 2).

### (2-2) Humidity Control Unit

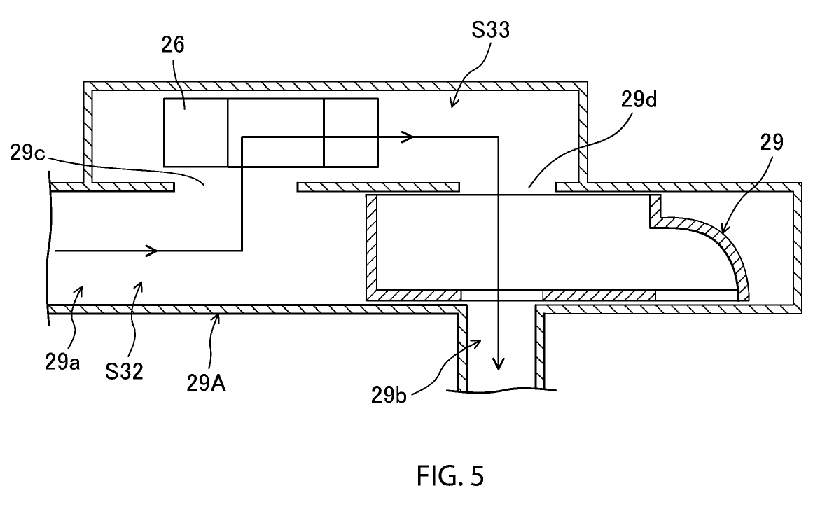

The humidity control unit (20) is installed outdoors. In this example, the humidity control unit (20) is integrated with the air conditioning outdoor unit (10). The humidity control unit (20) sends air having controlled humidity to the air conditioning indoor unit (30). The humidity control unit (20) includes the outdoor casing (11), a humidity control rotor (22), a first fan (26), a second fan (23), a heater (25), a first switching damper (24), and a second switching damper (29) (see FIG. 5). The outdoor casing (11) is shared between the air conditioning outdoor unit (10) and the humidity control unit (20).

Inside the outdoor casing (11), the above-described upper space (S2) is partitioned. The humidity control rotor (22) and the heater (25) are provided in the upper space (S2). To be exact, the humidity control rotor (22), the first fan (26), the second fan (23), the heater (25), the first switching damper (24), and the second switching damper (29) are provided in the upper space (S2).

The outdoor casing (11) has a suction/exhaust port (21a), a connection port (21b), and an outdoor exhaust port (21c). The suction/exhaust port (21a) is an opening through which outdoor air and indoor air flow. Inside the outdoor casing (11), a first passage (27) extending from the suction/exhaust port (21a) to the connection port (21b) is formed. Inside the outdoor casing (11), a third passage (62) extending from the moisture-absorption-side suction port (61a) to the moisture-absorption-side exhaust port (61b) is formed. The hose (2) is connected to the connection port (21b).

A second passage (28) is connected to the first passage (27). The second passage (28) extends from an intermediate portion of the first passage (27) to the outdoor exhaust port (21c). The inflow end of the second passage (28) is connected to a portion of the first passage (27) on the airflow-downstream side (to be exact, the downstream side of the first fan (26)) of the humidity control rotor (22). Here, in the first passage (27) and the second passage (28), the airflow refers to a direction (the direction indicated by the solid arrows in FIG. 2) in which air flows during an air-supplying operation.

### (2-2-1) Humidity Control Rotor

The air flowing in the first passage (27) passes through the humidity control rotor (22). The humidity control rotor (22) is an adsorbing member that adsorbs moisture in air. An adsorbent held by the humidity control rotor (22) may be an inorganic material such as silica gel, zeolite, or alumina. The adsorbent has a property of adsorbing moisture in air. A moisture absorbent has a property of desorbing the adsorbed moisture when heated.

The humidity control rotor (22) rotates by being driven by a second motor (M2). The humidity control rotor (22) has a humidity control region (22A) located in the first passage (27). In the humidity control region (22A), a regeneration operation in which the moisture adsorbed by the adsorbent is desorbed into air and an adsorption operation in which moisture in air is adsorbed by the adsorbent are performed.

### (2-2-2) First Fan

The first fan (26) is disposed on the downstream side of the humidity control region (22A) in the first passage (27). The first fan (26) conveys outdoor air so as to pass through the humidity control region (22A) of the humidity control rotor (22). The first fan (26) includes the first motor (M1). The air volume of the first fan (26) is switchable in a plurality of stages by adjusting the rotational speed of the first motor (M1). The first fan (26) is an example of the fan (26) in the present disclosure. Details of the structure of the first fan (26) will be described later.

### (2-2-3) Heater

The heater (25) is disposed on the upstream side of the humidity control region (22A) in the first passage (27). The heater (25) heats air flowing in the first passage (27). The output of the heater (25) is variable. The temperature of air passing through the heater (25) changes in accordance with the output of the heater (25).

### (2-2-4) Second Fan

The second fan (23) is disposed in the third passage (62). The second fan (23) conveys outdoor air so as to pass through the third passage (62). Outdoor air conveyed by the second fan (23) is sent into the third passage (62) through the moisture-absorption-side suction port (61a) and is discharged to the outside through the moisture-absorption-side exhaust port (61b). In the third passage (62), an adsorption region (22C) of the humidity control rotor (22) and the second fan (23) are disposed in this order from the upstream side to the downstream side in the airflow.

### (2-2-5) First Switching Damper

The first switching damper (24) is provided at a connection portion between the first passage (27) and the second passage (28). The first switching damper (24) may be constituted by a flow path switching valve, a shutter, or the like. The first switching damper (24) is switchable between a third state (the state indicated by the solid line in FIG. 2) and a fourth state (the state indicated by the dashed line in FIG. 2). The first switching damper (24) in the third state brings the first passage (27) and the inside of the hose (2) into communication and shuts off between the first passage (27) and the second passage (28). The first switching damper (24) in the fourth state shuts off between the first passage (27) and the inside of the hose (2) and brings the first passage (27) and the second passage (28) into communication. A state of the first switching damper (24) is switched by driving of a power source such as a motor.

### (2-2-6) Second Switching Damper

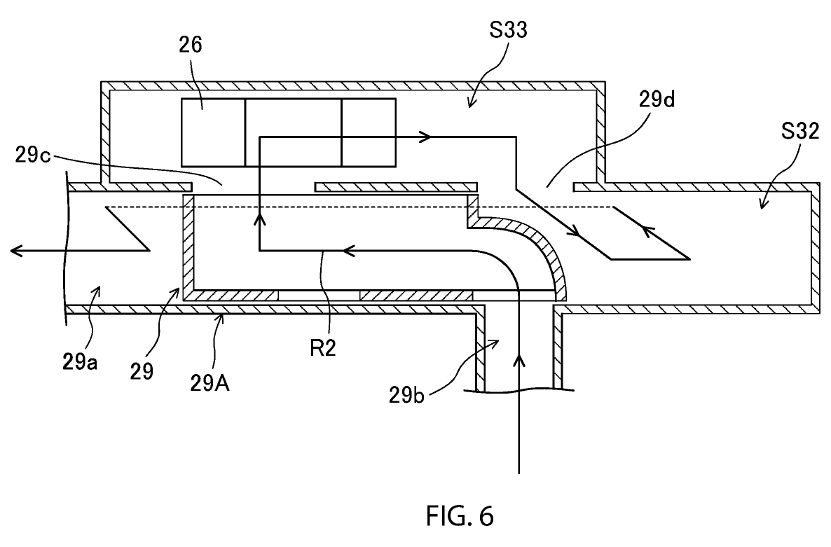

The second switching damper (29) is disposed in the first passage (27). As illustrated in FIGS. 5 and 6, the second switching damper (29) is provided in a damper casing (29A). In the damper casing (29A), a space (S32) in which the second switching damper (29) is disposed and a space (S33) in which the first fan (26) is disposed are provided. The second switching damper (29) slides within the space (S32). The damper casing (29A) has a first access port (29a) and a second access port (29b) that bring the space (S32) into communication with the outside of the damper casing (29A).

The first access port (29a) is in communication through the first passage (27) with the suction/exhaust port (21a). The second access port (29b) is in communication through the first passage (27) with the connection port (21b) of the outdoor casing (11) to which the hose (2) is connected. The second access port (29b) is in communication through the first passage (27) and the second passage (28) with the outdoor exhaust port (21c).

The damper casing (29A) is provided with a first communication port (29c) and a second communication port (29d) that bring the space (S32) and the space (S33) into communication. The second switching damper (29) is switchable between a fifth state and a sixth state by sliding within the space (S32). As illustrated in FIG. 5, in the second switching damper (29) in the fifth state, the first access port (29a) serves as an inlet for suction of air and the second access port (29b) serves as an outlet for exhaust of air. As illustrated in FIG. 6, in the second switching damper (29) in the sixth state, the second access port (29b) serves as an inlet for suction of air and the first access port (29a) serves as an outlet for exhaust of air. A state of the second switching damper (29) is switched by driving of a power source such as a motor.

### (2-3) Air Conditioning Indoor Unit

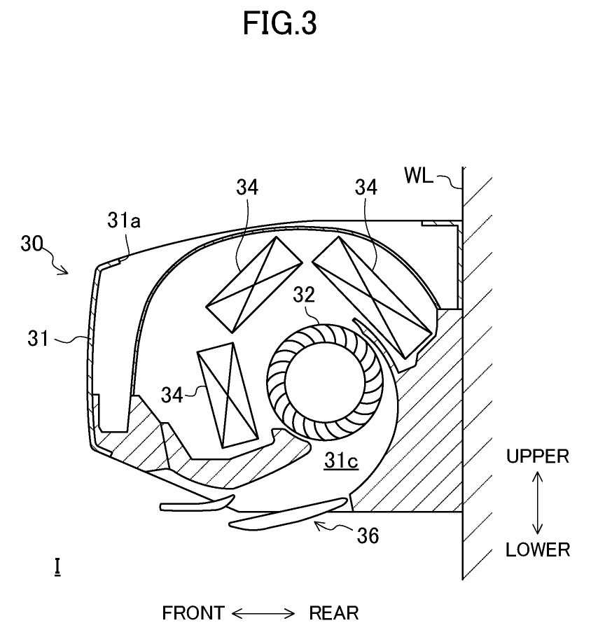

As illustrated in FIGS. 1 to 3, the air conditioning indoor unit (30) is installed indoors. The air conditioning indoor unit (30) is of a wall-mounted type installed on a wall (WL) of a room in which the interior (I) is formed. The air conditioning indoor unit (30) blows air to the interior (I). The air conditioning indoor unit (30) includes an indoor casing (31), an indoor fan (32), and the indoor heat exchanger (34).

The indoor casing (31) houses the indoor fan (32) and the indoor heat exchanger (34). The indoor casing (31) has an indoor suction port (31a) and an indoor blow-out port (31b).

The indoor suction port (31a) is disposed in an upper portion of the indoor casing (31). The indoor suction port (31a) is an opening for suction of indoor air. The indoor blow-out port (31b) is disposed in a lower portion of the indoor casing (31). The indoor blow-out port (31b) is an opening for blowing-out of air after heat exchange or air for humidity control. Inside the indoor casing (31), an indoor-air passage (31c) extending from the indoor suction port (31a) to the indoor blow-out port (31b) is formed.

The indoor fan (32) is disposed at a substantially central portion of the indoor-air passage (31c). The indoor fan (32) is, for example, a cross-flow fan.

The indoor heat exchanger (34) is disposed on the upstream side of the indoor fan (32) in the indoor-air passage (31c). The indoor heat exchanger (34) is of a fin-and-tube type. The indoor heat exchanger (34) exchanges heat between refrigerant inside the indoor heat exchanger (34) and indoor air conveyed by the indoor fan (32).

The air conditioning indoor unit (30) is connected to the humidity control unit (20) via the hose (2). Air sent from the humidity control unit (20) to the air conditioning indoor unit (30) is supplied through the hose (2) to the upstream side of the indoor heat exchanger (34) in the indoor-air passage (31c). Air sent from the air conditioning indoor unit (30) to the humidity control unit (20) flows from the upstream side of the indoor heat exchanger (34) in the indoor-air passage (31c) into the hose (2).

### (2-4) Remote Controller

As illustrated in FIGS. 2 and 4, the air conditioning apparatus (1) includes a remote controller (40). The remote controller (40) is disposed at a position indoors where a user can operate the remote controller (40). A user can set, by operating the remote controller (40), an operation mode, a target temperature, a target humidity, and the like of the air conditioning apparatus (1).

### (2-5) Sensors

The air conditioning apparatus (1) includes a plurality of sensors (not illustrated). The plurality of sensors include sensors for refrigerant and sensors for air. The sensors for refrigerant include sensors that detect the temperature or pressure of high-pressure refrigerant and sensors that detect the temperature or pressure of low-pressure refrigerant. The sensors for air detect an outside air temperature, an outside air humidity, an inside air temperature, an inside air humidity, and the like.

### (2-6) Control Unit

As illustrated in FIGS. 2 and 4, the air conditioning apparatus (1) includes a control unit (C). The control unit (C) controls an operation of the refrigerant circuit (R). The control unit (C) controls operations of the air conditioning outdoor unit (10), the humidity control unit (20), and the air conditioning indoor unit (30). The control unit (C) includes an outdoor control unit (OC), an indoor control unit (IC), and the remote controller (40). The outdoor control unit (OC) is provided in the air conditioning outdoor unit (10). The indoor control unit (IC) is provided in the air conditioning indoor unit (30). Each of the indoor control unit (IC) and the outdoor control unit (OC) includes a micro control unit (MCU), an electric circuit, and an electronic circuit. The MCU includes a central processing unit (CPU), a memory, and a communication interface. Various programs for execution by the CPU are stored in the memory.

### (3) Operation

Operation modes executed by the air conditioning apparatus (1) include a cooling operation, a heating operation, an air-supplying operation, an air-exhaust operation, a dehumidifying operation, a humidifying operation, a dehumidifying cooling operation, and a humidifying heating operation. The control unit (C) causes these operations to be executed on the basis of an instruction signal from the remote controller (40).

### (3-1) Cooling Operation

The cooling operation is an operation in which indoor air is cooled by the indoor heat exchanger (34) functioning as an evaporator. The humidity control unit (20) is stopped. In the cooling operation, the control unit (C) operates the compressor (12), the outdoor fan (13), and the indoor fan (32). The control unit (C) sets the four-way switching valve (16) to the first state. The control unit (C) controls the opening degree of the expansion valve (15), as appropriate. In the cooling operation, the first refrigeration cycle, in which compressed refrigerant releases heat at the outdoor heat exchanger (14) and evaporates at the indoor heat exchanger (34), is performed.

### (3-2) Heating Operation

The heating operation is an operation in which indoor air is heated by the indoor heat exchanger (34) functioning as a radiator. The humidity control unit (20) is stopped. In the heating operation, the control unit (C) operates the compressor (12), the outdoor fan (13), and the indoor fan (32). The control unit (C) sets the four-way switching valve (16) to the second state. The control unit (C) controls the opening degree of the expansion valve (15), as appropriate. In the heating operation, the second refrigeration cycle, in which refrigerant compressed by the compressor (12) releases heat at the indoor heat exchanger (34) and evaporates at the outdoor heat exchanger (14), is performed.

### (3-3) Air-Supplying Operation

The air-supplying operation is an operation in which outdoor air is supplied to an interior. In the air-supplying operation, as indicated by the solid arrows in FIG. 2, outdoor air is sent to the air conditioning indoor unit (30) through the hose (2). In the air-supplying operation, the control unit (C) stops the heater (25), the humidity control rotor (22), and the second fan (23) and operates the first fan (26). The control unit (C) sets the first switching damper (24) to the third state (the state indicated by the solid line in FIG. 2) and sets the second switching damper (29) to the fifth state (see FIG. 5). In the air-supplying operation, outdoor air conveyed by the first fan (26) is sent through the hose (2) to the air conditioning indoor unit (30) and is supplied through the indoor blow-out port (31b) of the air conditioning indoor unit (30) to the interior (I). The air-supplying operation may be performed simultaneously with the cooling operation or the heating operation.

### (3-4) Air-Exhaust Operation

The air-exhaust operation is an operation in which indoor air is discharged to the outside. In the air-exhaust operation, as indicated by the dashed arrows in FIG. 2, indoor air is sent to the humidity control unit (20) through the hose (2). In the air-exhaust operation, the control unit (C) stops the heater (25), the humidity control rotor (22), and the second fan (23) and operates the first fan (26). The control unit (C) sets the first switching damper (24) to the third state (the state indicated by the solid line in FIG. 2) and sets the second switching damper (29) to the sixth state (see FIG. 6). In the air-exhaust operation, indoor air conveyed by the first fan (26) is sent through the hose (2) to the humidity control unit (20) and is discharged to the outside through the suction/exhaust port (21a) of the humidity control unit (20). The air-exhaust operation may be performed simultaneously with the cooling operation or the heating operation.

### (3-5) Dehumidifying Operation

In the dehumidifying operation, air dehumidified by the humidity control unit (20) is supplied to an interior. In the dehumidifying operation, air dehumidified by the humidity control unit (20) is intermittently supplied to an interior. The humidity control unit (20) alternately performs a first operation and a second operation.

The first operation is an operation in which moisture in air is adsorbed by the humidity control rotor (22) and air dehumidified by the humidity control rotor (22) is supplied to an interior. Specifically, in the first operation, the control unit (C) operates the first fan (26), stops the second fan (23), stops the heater (25), sets the first switching damper (24) to the third state (the state indicated by the solid line in FIG. 2), and sets the second switching damper (29) to the fifth state (see FIG. 5).

The second operation is an operation in which the humidity control rotor (22) is regenerated and air used for regeneration is discharged to the outside. Specifically, in the second operation (regeneration processing of the humidity control rotor (22)), the control unit (C) operates the first fan (26) and the heater (25), stops the second fan (23), sets the first switching damper (24) to the fourth state (the state indicated by the dashed line in FIG. 2), and sets the second switching damper (29) to the fifth state (see FIG. 5).

### (3-6) Humidifying Operation

In the humidifying operation, air humidified by the humidity control unit (20) is supplied to an interior. In the humidifying operation, air humidified by the humidity control unit (20) is continuously supplied to an interior. The control unit (C) operates the first fan (26) and the second fan (23), rotationally drives the humidity control rotor (22), and sets the heater (25) to an ON state. The control unit (C) sets the first switching damper (24) to the third state and sets the second switching damper (29) to the fifth state.

Outdoor air flowing in the third passage (62) flows through the adsorption region (22C) of the humidity control rotor (22). In the adsorption region (22C), moisture in the air is adsorbed by the adsorbent. Air that has provided moisture to the humidity control rotor (22) is discharged to the outside from the third passage (62).

At the same time, outdoor air flowing in the first passage (27) is heated by the heater (25) and then flows through the humidity control region (22A) of the humidity control rotor (22). In the humidity control region (22A), moisture desorbed from the adsorbent is released into air. Air humidified by the humidity control rotor (22) is sent through the hose (2) to the air conditioning indoor unit (30) and is supplied through the indoor blow-out port (31b) of the air conditioning indoor unit (30) to the interior (I).

### (4) Details of First Fan

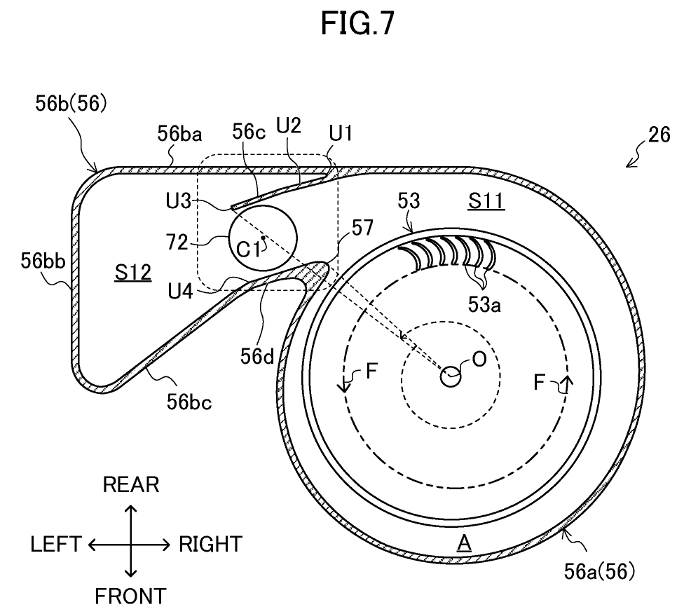

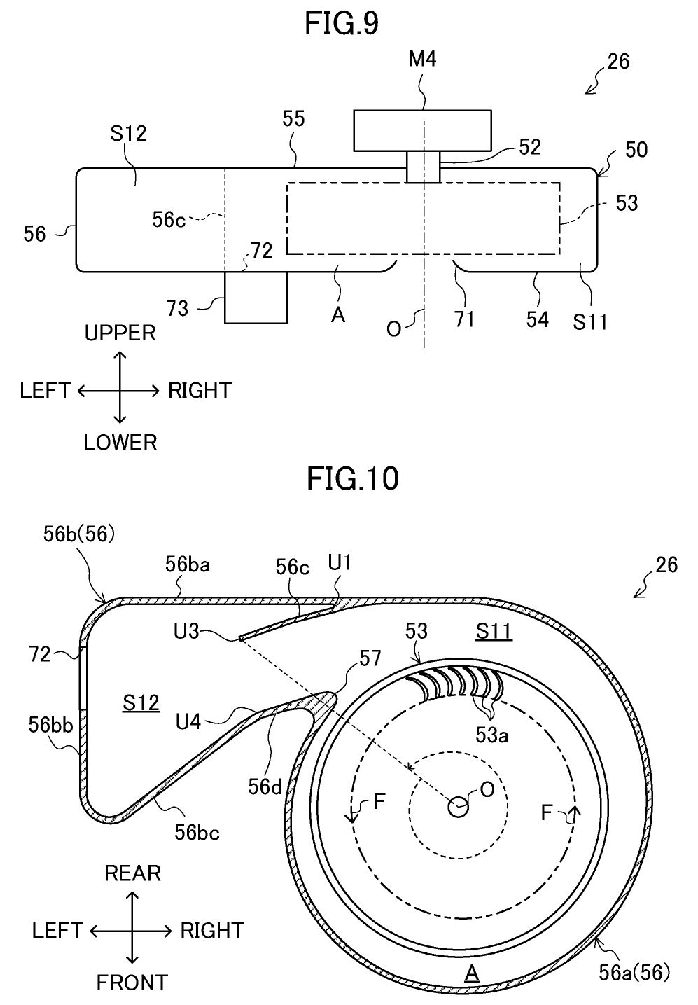

The first fan (26) illustrated in FIGS. 7 and 9 includes the first motor (M1), a drive shaft (52) rotationally driven by the first motor (M1), the impeller (53) coupled to the drive shaft (52), and a casing (50) housing the impeller (53). The drive shaft (52) is coupled to the first motor (M1). The impeller (53) includes a rotational axis (O) coupled to the drive shaft (52). The impeller (53) includes a plurality of blades (53a) arranged in the rotational direction (the direction indicated by the arrow F in FIG. 7) of the impeller (53).

The casing (50) includes a lower wall (54), an upper wall (55), and a side wall (56). In the direction of a rotational axis (O) of the impeller (53), when a side on which the first motor (M1) is disposed is defined as an upper side and a side opposite thereto is defined as a lower side, the lower wall (54) is disposed below the impeller (53), and the upper wall (55) is disposed above the impeller (53). The lower wall (54) and the upper wall (55) are formed substantially in point symmetry. The side wall (56) is a peripheral wall connected to outer edge portions of the lower wall (54) and the upper wall (55).

A housing space (S11) and a silencing space (S12) are formed inside the casing (50). The housing space (S11) and the silencing space (S12) are in communication with each other through an air passage (A) formed inside the casing (50). The air passage (A) is formed such that air flows from the housing space (S11) to the silencing space (S12). The casing (50) has a suction port (71) for taking air into the air passage (A) and a blow-out port (72) for blowing out air in the air passage (A) to outside the casing (50).

The housing space (S11) houses the impeller (53). The housing space (S11) is partitioned by portions of the lower wall (54) and the upper wall (55) facing the impeller (53) and by a first wall portion (56a).

The first wall portion (56a) is a part of the side wall (56). The first wall portion (56a) has a spiral shape extending along the outer peripheral edge of the impeller (53). In the housing space (S11), the air passage (A) is formed between the first wall portion (56a) and the impeller (53). The air passage (A) extends from one end to another end of the first wall portion (56a). The air passage (A) is in communication with the suction port (71). Air that has been drawn into the suction port (71) by rotation of the impeller (53) flows in the air passage (A). In the air passage (A), air flows in the rotational direction of the impeller (53). Thus, the air passage (A) extends along an inner surface of the first wall portion (56a). In the air passage (A), an airflow moving from the one end to the other end of the first wall portion (56a) is formed.

The suction port (71) is provided at one end in the direction of the rotational axis (O) of the impeller (53). In this example, the suction port (71) is formed in the lower wall (54). The suction port (71) is formed such that the center of the opening thereof is aligned with the rotational axis of the impeller (53). The air passing through the first communication port (29c) is drawn into the suction port (71).

The silencing space (S12) is a space in which noise generated by air flowing into the casing (50) is suppressed. The silencing space (S12) is partitioned by portions of the lower wall (54) and the upper wall (55) that do not face the impeller (53) and by a second wall portion (56b). The silencing space is an example of the first space (S12) in the present disclosure.

The silencing space (S12) is disposed adjacent to the housing space (S11). In the silencing space (S12) in this embodiment, the airflow-downstream end of the air passage (A) is disposed. In other words, a part of the air passage (A) is formed in the silencing space (S12). More specifically, an end portion of the first wall portion (56a) is disposed in the silencing space (S12). The silencing space (S12) is a space that serves as a so-called "dead end" in which air in the air passage (A) comes to a stop. The silencing space (S12) is formed to expand further from the downstream end of the air passage (A) toward the downstream of the airflow. Specifically, a flow path cross-sectional area of the silencing space (S12) is larger than a flow path cross-sectional area of the air passage (A) at the downstream end of the air passage (A). The silencing space (S12) has a silencing function due to irregular reflection of sound waves incident from the air passage (A) and mutual interference caused thereby.

The blow-out port (72) is disposed in the silencing space (S12). The blow-out port (72) is formed to be directed in a direction identical to the axial direction of the rotational axis of the impeller (53). Specifically, the blow-out port (72) is disposed in a portion of the lower wall (54) that partitions the silencing space (S12). The blow-out port (72) is disposed at the airflow-downstream end of the air passage (A). The blow-out port (72) is disposed on the downstream side of a tongue portion (57) at the one end of the first wall portion (56a) in the air passage (A). The closer the blow-out port (72) is to the tongue portion (57), the more likely noise is generated due to backflow of air at the tongue portion (57). In this embodiment, since the blow-out port (72) is disposed at a predetermined distance from the tongue portion (57), backflow of air at the tongue portion (57) is suppressed and generation of noise is suppressed. A tubular blow-out flow path (73) is connected to the blow-out port (72). The blow-out flow path (73) extends forward from the lower wall (54). Air is blown out from the blow-out flow path (73) to the second communication port (29d).

### (5) Details of First Wall Portion and Second Wall Portion

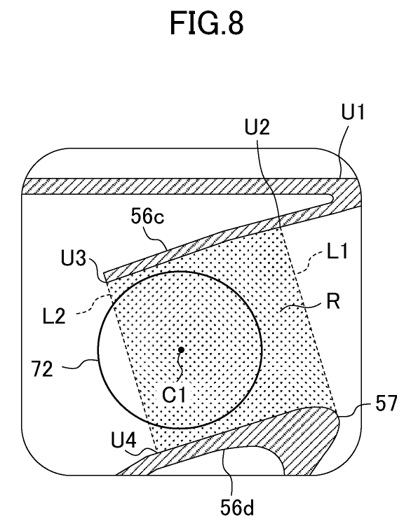

Details of the first wall portion (56a) and the second wall portion (56b) will be described with reference to FIGS. 7 and 8.

The tongue portion (57) is formed at the one end of the first wall portion (56a). The tongue portion (57) is a portion bulging inward in the casing (50) and guides air, which is blown out from the impeller (53), to the air passage (A).

Another end of the first wall portion (56a) is disposed at a position obtained by rotating by 360° or more, with the position of the tongue portion (57) formed at the one end of the first wall portion (56a) as a starting point, about the rotational axis (O) in a rotational direction of the impeller (53). Specifically, the other end of the first wall portion (56a) is disposed at a position (refer to the dashed arrow in FIG. 7) of a line, which connects the center of the rotational axis (O) to a tip of the tongue portion (57), rotated by 360° or more about the rotational axis (O) in the rotational direction of the impeller (53). Thus, the first wall portion (56a) extends beyond the entire circumference of the impeller (53).

In this embodiment, an end portion of the first wall portion (56a) is disposed in the silencing space (S12). Specifically, the other end of the first wall portion (56a) extends from a first position (U1) located at an intermediate portion of the first wall portion (56a) toward the inside of the silencing space (S12). In the first wall portion (56a), the first position (U1) is a position obtained by rotating by a predetermined angle, with the position of the tip of the tongue portion (57) as a starting point, about the rotational axis (O) in the rotational direction of the impeller (53). The predetermined angle is not limited and may be, for example, 270° or more, 300° or more, or 360° or more when the position of the tip of the tongue portion (57) is defined as 0°. When a portion extending from the first position (U1) to the other end of the first wall portion (56a) is defined as an other-end-side first wall portion (56c), the other-end-side first wall portion (56c) inclines or curves from the first position (U1) toward a position where the blow-out port (72) is disposed.

One end of the second wall portion (56b) is connected to the one end of the first wall portion (56a). In other words, the one end of the second wall portion (56b) is connected to the tongue portion (57). Another end of the second wall portion (56b) is connected to an intermediate portion of the first wall portion (56a). Specifically, the other end of the second wall portion (56b) is connected to the first position (U1) in the first wall portion (56a). The other end of the second wall portion (56b) is connected so as to be continuous with the first wall portion (56a) at the first position (U1). In other words, the other-end-side first wall portion (56c) extends from the first position (U1) toward the blow-out port (72) so as to branch from the second wall portion (56b).

The second wall portion (56b) includes a rear second wall portion (56ba), a left second wall portion (56bb), and a front second wall portion (56bc). The rear second wall portion (56ba) extends leftward from the first position (U1). The left second wall portion (56bb) extends from the left end of the rear second wall portion (56ba) to a position forward of the blow-out port (72). The front second wall portion (56bc) extends so as to incline from the front end of the left second wall portion (56bb) to the tongue portion (57).

Of the front second wall portion (56bc), a portion from the tongue portion (57) to a fourth position (U4) is defined as a one-end-side second wall portion (56d). The one-end-side second wall portion (56d) faces the other-end-side first wall portion (56c). In other words, the air passage (A) is formed between the one-end-side second wall portion (56d) and the other-end-side first wall portion (56c). A distance between the one-end-side second wall portion (56d) and the other-end-side first wall portion (56c) is the same as or slightly larger than an inner diameter of an opening of the blow-out port (72).

A center C1 of the opening of the blow-out port (72) is disposed between a second position (U2) in the first wall portion (56a) facing the tongue portion (57) in the air passage (A) and a third position (U3) that is the other end of the first wall portion (56a). As illustrated in FIG. 8, the second position (U2) in this embodiment is a point at which a straight line extending from the tip of the tongue portion (57) to the other-end-side first wall portion (56c) so as to be orthogonal to the airflow intersects the other-end-side first wall portion (56c). The center C1 of the opening of the blow-out port (72) is disposed in a region R (dotted region in FIG. 8) in the air passage (A) between a dashed line (dashed line L1 in FIG. 8) orthogonal to the airflow at the second position (U2) and a dashed line (dashed line L2 in FIG. 8) orthogonal to the airflow at the third position (U3). Thus, the blow-out port (72) is disposed such that at least a part of the opening thereof overlaps the air passage (A).

### (6) Features

### (6-1) Feature 1

A fan (26) in this embodiment includes the casing (50) including the first wall portion (56a) having a spiral shape extending along the outer peripheral edge of the impeller (53). The other end of the first wall portion (56a) is at a position obtained by rotating by 360° or more, with the position of the tongue portion (57) formed at the one end of the first wall portion (56a) as a starting point, about the rotational axis (O) in the rotational direction of the impeller (53).

According to this embodiment, the first wall portion (56a) is disposed so as to surround at least the entire circumference of the impeller (53). With such a first wall portion (56a), recovery of the dynamic-pressure component of air discharged from the impeller (53) by rotation of the impeller (53) can be improved. That is, conversion from dynamic pressure to static pressure is accelerated. In other words, kinetic energy flowing out from the impeller (53) is recovered as pressure energy. Since generation of noise as blowing sound is related to dynamic pressure, when the dynamic pressure portion is suppressed, generation of blowing sound can also be suppressed. In addition, since dynamic pressure is recovered, static pressure efficiency can be improved, and attenuation of the airflow of air flowing toward the blow-out port (72) can be suppressed.

### (6-2) Feature 2

In the fan (26) in this embodiment, the other end of the first wall portion (56a) extends from the first position (U1) to which the other end of the second wall portion (56b) is connected toward the blow-out port (72) in the silencing space (S12).

According to this embodiment, the silencing space (S12) also serves as a part of the air passage (A). Thus, by providing a part of the air passage (A) in the silencing space (S12), an increase in size of the fan (26) can be suppressed.

### (6-3) Feature 3

In the fan (26) in this embodiment, the center C1 of the opening of the blow-out port (72) is disposed between the second position (U2) in the first wall portion (56a) facing the tongue portion (57) in the air passage (A) and the third position (U3) that is the other end of the first wall portion (56a).

Since at least a part of the opening of the blow-out port (72) overlaps the air passage (A), air can be conveyed to the blow-out port (72) while a dynamic pressure portion of the air is suppressed with static pressure being ensured. As a result, generation of blowing sound and attenuation of the airflow can be suppressed.

### (7) Other Embodiments

The above-described embodiment may have the following configurations.

As illustrated in FIG. 10, the blow-out port (72) may be provided in the second wall portion (56b). As a result, air blown out from the air passage (A) to the silencing space (S12) expands, and air flowing from the silencing space (S12) into the blow-out port (72) contracts. With expansion and contraction of air thus occurring successively, generation or sound volume of noise can be suppressed. In the above embodiment, the blow-out port (72) may be provided in any of the rear second wall portion (56ba), the left second wall portion (56bb), and the front second wall portion (56bc). However, it is preferable that the blow-out port (72) be provided in the left second wall portion (56bb) facing the downstream end of the air passage (A).

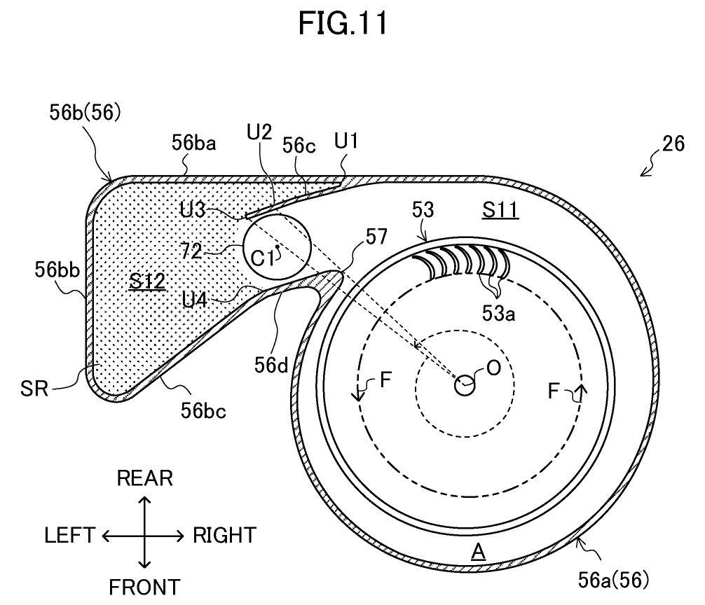

As illustrated in FIG. 11, a silencing material (SR) may be provided in the silencing space (S12) (dotted region in FIG. 11). It is sufficient for the silencing material (SR) to be made of, for example, a material that absorbs sound and may be, for example, a porous material formed of resin, ceramic, or the like.

The first wall portion (56a) does not necessarily have the other-end-side first wall portion (56c). That is, the other end of the second wall portion (56b) may be not connected to the first position (U1) and may be connected to the other end of the first wall portion (56a).

The casing (50) does not necessarily have the silencing space (S12). In this case, the blow-out port (72) is connected to the airflow-downstream end of the air passage (A).

The fan (26) is not necessarily provided in the air conditioning outdoor unit (10) in the above embodiment. That is, the fan (26) may be provided in an air conditioning outdoor unit not including the humidity control unit (20), or may be provided in an apparatus different from the air conditioning outdoor unit.

The fan (26) is not necessarily provided in the air conditioning apparatus (1). For example, the fan (26) may be provided in a ventilation apparatus.

It is sufficient for the fan (26) to be a centrifugal fan including a scroll-shaped inner wall disposed around the impeller (53).

Although embodiments and modified examples have been described above, it will be understood that various changes in forms and details can be made without departing from the spirit and scope of the claims. The above embodiments and modified examples may be combined or replaced, as appropriate, as long as functions of the subject of the present disclosure are not impaired. The above-described expressions "first", "second", and so on are used to distinguish terms to which these expressions are assigned and are not intended to limit the number or the order of the terms.

As described above, the present disclosure is useful for a fan, an air conditioning outdoor unit, and an air conditioning apparatus.

1. A fan comprising:
an impeller; and
a casing configured to house the impeller, the casing including
a first wall portion having a spiral shape extending along an outer peripheral edge of the impeller,
a suction port at one end in a direction of a rotational axis of the impeller,
an air passage extending along an inner surface of the first wall portion to be in communication with the suction port and in which an airflow moving from one end toward an other end of the first wall portion is formed, and
a blow-out port through which air in the air passage is blown out to outside the casing, and
the other end of the first wall portion being at a position obtained by rotating by 360° or more, with a position of a tongue portion formed at the one end of the first wall portion as a starting point, about the rotational axis in a rotational direction of the impeller.

2. The fan according to claim 1, wherein
the casing includes a second wall portion configured to partition a first space in which the blow-out port is disposed, the first space being in communication with an airflow-downstream end of the air passage,
one end of the second wall portion is connected to the one end of the first wall portion,
an other end of the second wall portion is connected to, in the first wall portion, a first position obtained by rotating by a predetermined angle, with a position of the tongue portion as a starting point, about the rotational axis in a rotational direction of the impeller, and
the other end of the first wall portion extends from the first position into the first space.

3. The fan according to claim 1, wherein
the blow-out port is formed to be directed in a direction identical to an axial direction of the rotational axis, and
a center of an opening of the blow-out port is disposed between
a second position in the first wall portion facing the tongue portion in the air passage and
a third position at the other end of the first wall portion.

4. The fan according to claim 2, wherein
the blow-out port is formed to be directed in a direction identical to an axial direction of the rotational axis, and
a center of an opening of the blow-out port is disposed between
a second position in the first wall portion facing the tongue portion in the air passage and
a third position at the other end of the first wall portion.

5. The fan according to claim 2, wherein
the blow-out port is provided in the second wall portion.

6. The fan according to claim 2, wherein
a silencing material is provided in the first space.

7. An air conditioning outdoor unit including the fan according to claim 1, wherein
the air conditioning outdoor unit is configured to be disposed outside a target space to constitute an air conditioning apparatus configured to air-condition the target space.

8. An air conditioning outdoor unit including the fan according to claim 2, wherein
the air conditioning outdoor unit is configured to be disposed outside a target space to constitute an air conditioning apparatus configured to air-condition the target space.

9. An air conditioning outdoor unit including the fan according to claim 3, wherein
the air conditioning outdoor unit is configured to be disposed outside a target space to constitute an air conditioning apparatus configured to air-condition the target space.

10. An air conditioning outdoor unit including the fan according to claim 5, wherein
the air conditioning outdoor unit is configured to be disposed outside a target space to constitute an air conditioning apparatus configured to air-condition the target space.

11. An air conditioning outdoor unit including the fan according to claim 6, wherein
the air conditioning outdoor unit is configured to be disposed outside a target space to constitute an air conditioning apparatus configured to air-condition the target space.

12. An air conditioning apparatus including the air conditioning outdoor unit according to claim 7, the air conditioning apparatus further comprising:
an air conditioning indoor unit connected to the air conditioning outdoor unit by a connection pipe, the air conditioning indoor unit being configured to blow out air to the target space.

13. An air conditioning apparatus including the air conditioning outdoor unit according to claim 8, the air conditioning apparatus further comprising:
an air conditioning indoor unit connected to the air conditioning outdoor unit by a connection pipe, the air conditioning indoor unit being configured to blow out air to the target space.

14. An air conditioning apparatus including the air conditioning outdoor unit according to claim 9, the air conditioning apparatus further comprising:
an air conditioning indoor unit connected to the air conditioning outdoor unit by a connection pipe, the air conditioning indoor unit being configured to blow out air to the target space.

15. An air conditioning apparatus including the air conditioning outdoor unit according to claim 10, the air conditioning apparatus further comprising:
an air conditioning indoor unit connected to the air conditioning outdoor unit by a connection pipe, the air conditioning indoor unit being configured to blow out air to the target space.

16. An air conditioning apparatus including the air conditioning outdoor unit according to claim 11, the air conditioning apparatus further comprising:
an air conditioning indoor unit connected to the air conditioning outdoor unit by a connection pipe, the air conditioning indoor unit being configured to blow out air to the target space.
